(19) United States
(12) Patent Application Publication
(10) Pub. No.: US 2020/0071991 A1
(43) Pub. Date: Mar. 5, 2020

(54) Delivery-Receiving Door

(71) Applicant: Rupesh Jayesh Patel, East Brunswick, NJ (US)

(72) Inventor: Rupesh Jayesh Patel, East Brunswick, NJ (US)

(21) Appl. No.: 16/118,300

(22) Filed: Aug. 30, 2018

(51) Int. Cl. E06B 7/32; E06B 7/28; A47G 29/14

(52) U.S. Cl. CPC E06B 7/32; E06B 7/28; A47G 2029/147; A47G 2029/145; A47G 29/141

(57) ABSTRACT

A delivery-receiving door is an apparatus that is used to collect deliveries and store them for storage and subsequent access. The apparatus includes an exterior door, a collapsible tube, a controller, a first access mechanism, and a second access mechanism. The exterior door is similar to a conventional entryway door, allowing selective hinged entry into a living space. The collapsible tube is mounted to the exterior door. This allows the collapsible tube to expand for containment of items. The controller is a computer that accepts electrical input signals related to the first access mechanism and the second access mechanism, and subsequently delivers electrical output signals. The first access mechanism allows for input of delivered packages and items into the collapsible tube, while the second access mechanism allows for removal of delivered packages and items from the collapsible tube.

### FIELD OF THE INVENTION

The present invention generally relates to a delivery management tool. More specifically, the present invention is a delivery-receiving door that relates to a security system with compartments for containing various deliveries, including packages, cold foods, and hot foods. The present invention further utilizes a series of sensors to verify delivery information, as well as wireless connectivity that allows a user to interact with the present invention from afar.

### BACKGROUND OF THE INVENTION

Modern package delivery infrastructure enables consumers to order items online and subsequently receive purchased items through the mail. The services providing these items continue to grow more popular, as the number of consumers who shop exclusively online perpetually increases. In the not-so-distant future, it is likely that online shopping will grow to include grocery shopping and may even utilize drones for delivery, further enhancing the efficiency of such systems. While many items are presently shipped across the world every day and delivered to a consumer's area, the consumer needs to be present to receive some items, especially for deliveries of larger or more expensive items and for food.

Therefore, in order to fully benefit from the convenience of online shipping, the user must be prepared to receive packages, which presents several challenges. An optimal delivery receipt system must be prepared to accommodate produce and hot deliveries and must be fully secure in both software and hardware to prevent theft. Such a delivery system would need to interact with the consumer, providing visual information about the delivery person or drone. The system would also need to be able to scan or otherwise interact with contained items, so that the user knows precisely which items are arriving. Furthermore, a fully-equipped package-receiving apparatus must be equipped with biometric sensors to allow approved users to access contained items. A device that integrates into a door is desirable as such a device would take minimal space and would integrate with the entrance to the house so that the user could utilize the provided security benefits on their primary home door. What is needed is a device that can inspect, store, and provide selective access to a wide variety of delivery items, including perishables. Further desirable is such a device that can interact with the user to allow secure access to the user's house.

The present invention addresses these issues. The delivery-receiving door allows a user to enter and exit a house by verifying the user's identity, using either a touchscreen interface or using a variety of biometric sensors and scanners. Several of these sensors and interfaces, coupled with a camera and some other sensors, allow the present invention to determine information about the deliverer and the package. A door and gate protect contained items from theft or tampering by hostile entities. The inside of the present invention is split into several containers, which collapse when in disuse. These containers are insulated to provide thermal consistency, thus allowing for containment of perishable items and hot foods.

### BRIEF DESCRIPTION OF THE DRAWINGS

FIG. 1 is a front schematic view of the present invention.

FIG. 2 is a front sectional schematic view of the present invention.

FIG. 3 is a front schematic view of the collapsing tube.

FIG. 4 is a right schematic view of the present invention.

FIG. 5 is a block diagram depicting the electronic connections among the controller, the camera, the at least one short-range item-identifying sensor, the at least one short-range user-identifying sensor, the wireless transceiver, the user interface, and the locking mechanism.

### DETAILED DESCRIPTION OF THE INVENTION

All illustrations of the drawings are for the purpose of describing selected versions of the present invention and are not intended to limit the scope of the present invention.

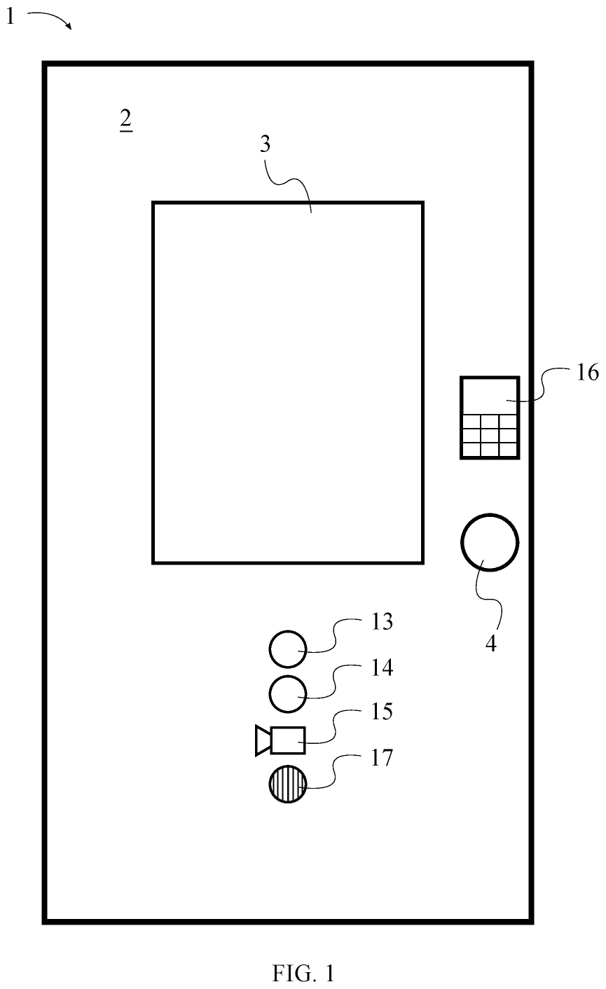

The delivery-receiving door is an apparatus that is used to collect package deliveries and store them for storage and subsequent access. The present invention is further configured to provide a novel home security system that utilizes cameras, biometrics, and other sensor-based technologies to validate the identity of the user. The apparatus includes an exterior door 1, a collapsible tube 5, a controller 8, a first access mechanism 9, and a second access mechanism 12, as seen in FIG. 1. The exterior door 1 hinges to allow selective entry into a living space. The collapsible tube 5 is mounted to the exterior door 1. This allows the collapsible tube 5 to expand for containment of items. The controller 8 is a computing device that accepts electrical input signals related to the first access mechanism 9 and the second access mechanism 12 and subsequently delivers electrical output signals. In this way, the controller 8 toggles the locked/unlocked status of the first access mechanism 9 and the second access mechanism 12. The first access mechanism 9 allows for access into the collapsible tube 5. Similarly, the second access mechanism 12 allows for access into the collapsible tube 5 on the opposite end from the first access mechanism 9. In this way, deliveries can easily enter and exit the present invention.

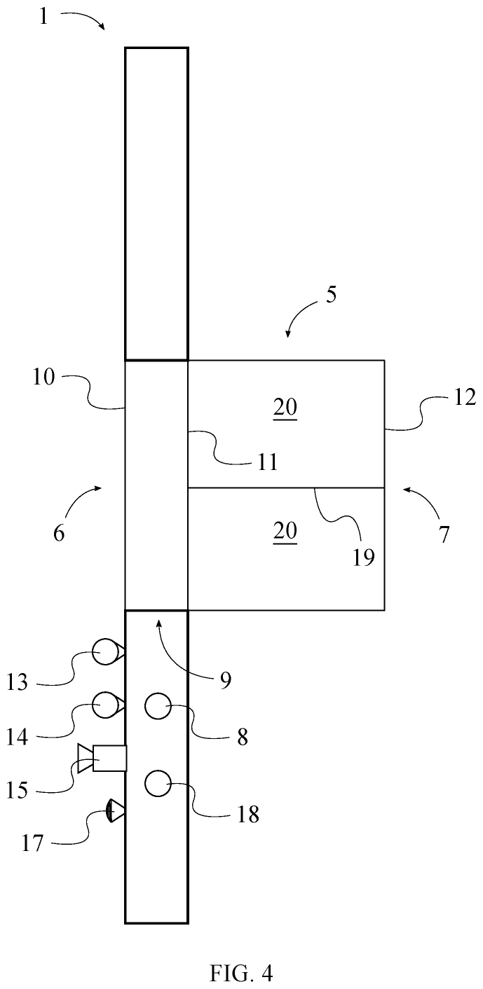

Furthermore, the exterior door 1 comprises a door body 2, a window 3, and a locking mechanism 4. The door body 2 is the solid unit upon which the collapsible tube 5 is mounted. The window 3 is an opening within the door body 2 that allows the collapsible tube 5 to mount appropriately, as seen in FIG. 4. The locking mechanism 4 is a rigid extrusion extending from the exterior door 1 that controls the ability of the exterior door 1 to hinge by, in an exemplary embodiment, extending into a door frame. The collapsible tube 5 comprises a first open end 6 and a second open end 7. The first open end 6 is an opening into the collapsible tube 5 that allows for input of items and packages. Conversely, the second open end 7 is an opening into the collapsible tube 5 that allows the user to remove items from within the collapsible tube 5.

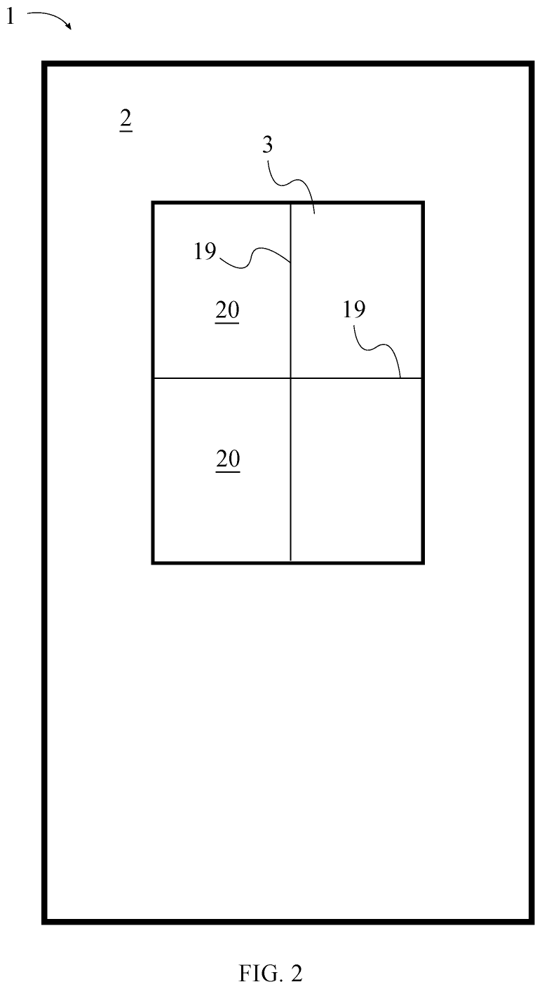

The general configuration of the aforementioned components allows the present invention to accept, contain, and protect items that are delivered. The window 3 traverses normal through the door body 2, as seen in FIG. 2. This creates a level mounting surface for the first open end 6. The first open end 6 is perimetrically connected to the window 3. This arrangement allows for convenient and intuitive insertion of items through the window 3 into the collapsible tube 5. The second open end 7 is positioned offset from the door body 2. In this way, the user can access within the collapsible tube 5 opposite the first open end 6. Further, in an exemplary embodiment, the second open end 7 may be made of fogging glass that comprises a button. In this way, the user could press the button to fog the glass, thus preventing a delivery person from looking inside the user's house. The user could then press the button again to un-fog the second open end 7. In this way, a user could see items within the collapsible tube 5 without being exposed to such items. The first access mechanism 9 is operatively integrated into the first open end 6, wherein the first access mechanism 9 is used to selectively allow access to the collapsible tube 5. In this way, the first access mechanism 9 provides access to the inside of the collapsible tube 5. Similarly, the second access mechanism 12 is operatively integrated into the second open end 7, wherein the second access mechanism 12 is used to selectively allow access to the collapsible tube 5. In this way, the second access mechanism 12 provides access to the inside of the collapsible tube 5. The controller 8 is electronically connected to the locking mechanism 4 and the first access mechanism 9. This arrangement allows the controller 8 to toggle the locked/unlocked status of the locking mechanism 4 and consequently grant or deny a user access to the collapsible tube 5. Because the locking mechanism 4 is electronically connected to the controller 8, the controller 8 can be utilized to electronically control the present invention.

In order to assess items and packages that interact with the present invention, a series of electrical sensors is utilized. The present invention comprises at least one short-range item-identifying sensor 13. The at least one short-range item-identifying sensor 13 is a set of electrical components that are capable of relaying electrical signals in response to captured signals. The at least one short-range item-identifying sensor 13 is mounted onto the door body 2, as seen in FIG. 1. Further, the at least one short-range item-identifying sensor 13 is oriented away from the collapsible tube 5. This positioning ensures the at least one short-range item-identifying sensor 13 is arranged optimally for use. The at least one short-range item-identifying sensor 13 is electronically connected to the controller 8. This allows signals sent from the at least one short-range item-identifying sensor 13 to connect to the controller 8 for interpretation. Further, the present invention may include several different sensors that provide different sensory inputs to the controller 8. In an exemplary embodiment, the at least one short-range item-identifying sensor 13 is selected from a group consisting of: a radio-frequency identification (RFID) sensor, a quick response (QR) code scanner, a personal-area networking transceiver, and combinations thereof. These sensors would provide the present invention with a way to identify packages that are equipped with various tags and wireless communication tools.

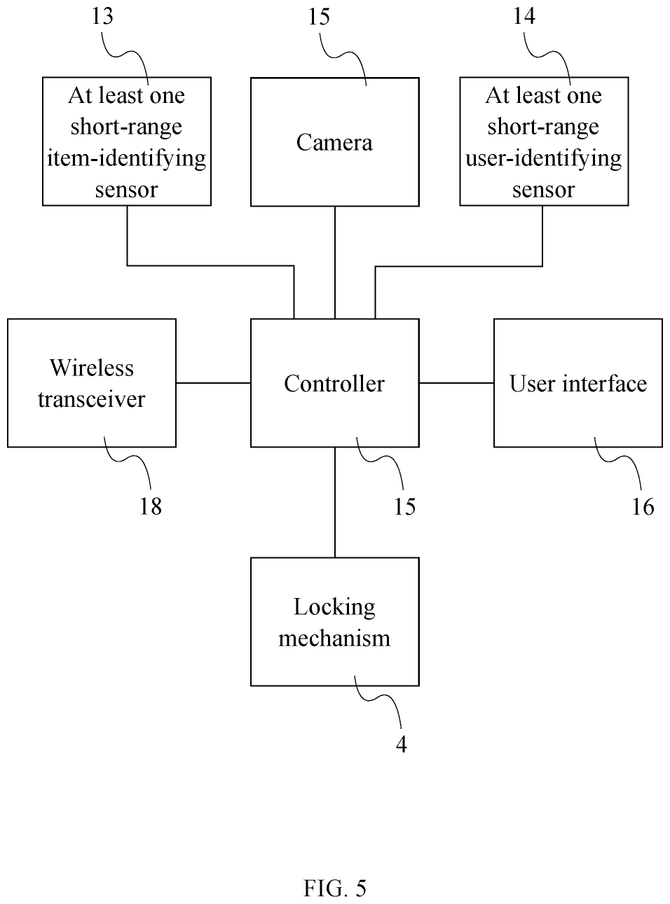

In addition to identifying packages, the present invention further enables the identification of approaching parties, including people and drones. The present invention comprises at least one short-range user-identifying sensor 14. The at least one short-range user-identifying sensor 14 is a set of electrical components that are capable of relaying electrical signals in response to captured signals. The at least one short-range user-identifying sensor 14 is mounted onto the door body 2. Further, the at least one short-range user-identifying sensor 14 is oriented away from the collapsible tube 5. This positioning ensures the at least one short-range user-identifying sensor 14 is arranged optimally for use. The at least one short-range user-identifying sensor 14 is electronically connected to the controller 8. This allows signals sent from the at least one short-range user-identifying sensor 14 to connect to the controller 8 for interpretation. Among the possible signal-generating devices that could be sent to the controller, the present invention generally includes several specific sensors that provide different sensory inputs to the controller 8, as seen in FIG. 5. The at least one short-range user-identifying sensor 14 is selected from a group consisting of: a radio-frequency identification (RFID) sensor, an optical scanner, a personal-area networking transceiver, a biometric scanner, and combinations thereof. These specific sensors would further allow for identification of and wireless connection between delivery people or drones equipped with wireless transceivers and the present invention and further may identify the presence of people or drones in front of the present invention. This improves the security created by the present invention by providing the user with information regarding the presence of various parties proximal to the present invention.

To identify people and items that approach the present invention, the present invention comprises a camera 15. The camera 15 is an image-capturing device that acquires data about nearby objects. In an exemplary embodiment in which the present invention includes a mobile application, the camera 15 allows for the transmittance of video and other visual information to the user's device. The camera 15 is pivotably mounted onto the door body 2, as seen in FIG. 1. This arrangement allows the camera 15 to swivel and move to capture images at various angles and in various directions. The camera 15 is oriented away from the collapsible. This positioning ensures the camera 15 is arranged optimally for use. The camera 15 is electronically connected to the controller 8. This electronic connection allows the camera 15 to capture pictures as commanded by the controller 8, and subsequently allows for data captured by the camera 15 to be stored and subsequently utilized by the controller 8. In an exemplary embodiment, a signal from the at least one short-range user-identifying sensor 14 indicating the presence of an unknown entity can trigger the camera 15 to capture a photograph or video footage of the entity. Alternatively, the camera 15 may respond in a time-dependent manner, for example, capturing a picture every five minutes.

In order for approaching parties to tactilely interact with the present invention, the present invention must include a mechanism for accepting user inputs. To this end, the present invention comprises a user interface 16. The user interface 16 is any of a variety of coordinated switches, buttons, levers, and other inputs combined with a monitor or screen for providing visual feedback to a user. In an exemplary embodiment, the user interface 16 is a touchscreen device. The user interface 16 is mounted onto the door body 2, as seen in FIG. 1. Further, the user interface 16 is oriented away from the collapsible tube 5. This arrangement allows for the user to interact with the user interface 16. The user interface 16 is electronically connected to the controller 8. In this way, signals captured from the user interface 16 may be interpreted by the controller 8 for subsequent relaying of signals. A user of the present invention further may desire to audibly interact with approaching parties. The present invention therefore comprises a speaker 17, which is used to provide a way for a user to verbally communicate with approaching parties. The speaker 17 is an audio device capable of converting electrical signals into audio waves and subsequently amplifying those audio waves to audible levels. The speaker 17 is mounted onto the door body 2. The speaker 17 is electronically connected to the controller 8. In this way, inputs processed by the controller 8 are subsequently converted into electrical signal outputs by the speaker 17.

To communicate with the user, the present invention is equipped to send and receive signals from the user. The present invention comprises a wireless transceiver 18, as seen in FIG. 4. The wireless transceiver 18 is an adapter that allows the user to send the present invention signals which can be interpreted and converted into instructions for the present invention. The wireless transceiver 18 is electronically connected to the controller 8. This allows the wireless transceiver 18 to interpret and receive information from the controller 8. The wireless transceiver 18 is especially useful in an exemplary embodiment of the present invention in which the present invention includes a mobile application which the user may utilize to interact with the speaker 17.

As described above, the first access mechanism 9 provides access to the collapsible tube 5. The first access mechanism 9 comprises a first thermally-insulated door 10 and a security gate 11, as seen in FIG. 4. The first thermally-insulated door 10 is a hinged wall that protects the contents of the collapsible tube 5. The security gate 11 is a folding closure that improves the physical security of the present invention, further preventing unauthorized user access to the collapsible tube 5. The security gate 11 is operatively coupled to the first open end 6, wherein the security gate 11 is used to provide selective access to the collapsible tube 5. This arrangement allows the security gate 11 to enhance the protection provided by the first thermally-insulated door 10. The first thermally-insulated door 10 is operatively coupled to the first open end 6, wherein the first thermally-insulated door 10 is used to thermally regulate the collapsible tube 5. This arrangement ensures that the cold or hot chambers within the present invention remain insulated in order to prevent heat loss. The security gate 11 is positioned in between the first thermally-insulated door 10 and the first open end 6. This arrangement ensures that the first thermally-insulated door 10 is appropriately positioned to create enclosed thermal chambers with respect to the collapsible tube 5. In an exemplary embodiment, a delivery person would approach the present invention with a delivery. The at least one short-range user-identifying sensor 14 would identify the delivery person and provide a notification to the user via the wireless transceiver 18 that a person is proximal to the present invention. The delivery person would scan items using the at least one short-range item-identifying sensor 13. The controller 8 would then allow the delivery person to open the first open end 6.

The user may wish to access packages and items within the collapsible tube 5 from inside the user's home. To this end, the second access mechanism 12 is a second thermally-insulated door, seen in FIG. 4. The second thermally-insulated door is a closure that provides an alternative access mechanism for the collapsible tube 5. The second thermally-insulated door is operatively coupled to the second open end 7, wherein the second thermally-insulated door is used to thermally regulate the collapsible tube 5. In this way, the second thermally-insulated door maintains the thermal chambers within the collapsible tube 5, thus keeping cold items cold and hot items hot.

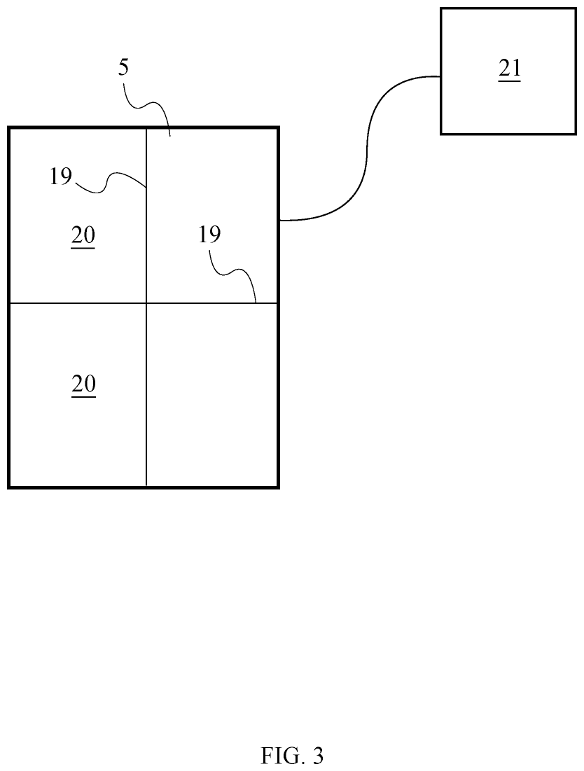

The collapsible tube 5 must be prepared to accept, separate, and contain different items based on the thermal requirements of the items. To this end, the present invention comprises a plurality of collapsible dividers 19, as seen in FIGS. 2 and 3. The plurality of collapsible dividers 19 is a set of collapsing walls that define and separate different sections within the collapsible tube 5. The plurality of collapsible dividers 19 is mounted within the collapsible tube 5. This allows for the creation of compartments for separating items based on thermal requirements. Further, a plurality of compartments 20 of the collapsible tube 5 is delineated by the plurality of collapsible dividers 19. The plurality of compartments 20 is a series of spaces within the collapsible tube 5 that allow for arrangement of packages and items. Further, the collapsible tube 5 comprises a refrigeration system 21. The refrigeration system 21 provides and maintains the low temperature of one or several compartments of the plurality of compartments 20. The refrigeration system 21 is in thermal communication with at least one compartment from the plurality of compartments 20. This arrangement allows the refrigeration system 21 to create a low-temperature environment for cold or cool packages and items.

The collapsible tube 5 may collapse in a variety of different ways. The collapsible tube 5 may utilize a series of beams connected pivotably end-to-end to provide an accordion effect that allows the collapsible tube 5 to collapse. Alternatively, a series of connected tubes may provide the collapsible tube 5 with the ability to telescope closed. In another alternative embodiment, several hinged connectors allow the collapsible tube 5 to swing open and remain open when items are placed within. Many different embodiments are possible, and the described embodiments are not meant to be limiting.

Although the invention has been explained in relation to its preferred embodiment, it is to be understood that many other possible modifications and variations can be made without departing from the spirit and scope of the invention as hereinafter claimed.

What is claimed is:

1. A delivery-receiving door comprises:
an exterior door;
a collapsible tube;
a controller;
a first access mechanism;
a second access mechanism;
the exterior door comprises a door body, a window, and a locking mechanism;
the collapsible tube comprises a first open end and a second open end;
the window traversing normal through the door body;
the first open end being perimetrically connected to the window;
the second open end being positioned offset from the door body;
the first access mechanism being operatively integrated into the first open end, wherein the first access mechanism is used to selectively allow access to the collapsible tube;
the second access mechanism being operatively integrated into the second open end, wherein the second access mechanism is used to selectively allow access to the collapsible tube; and
the controller being electronically connected to the locking mechanism and the first access mechanism.

2. The delivery-receiving door as claimed in claim 1 comprises:
at least one short-range item-identifying sensor;
the at least one short-range item-identifying sensor being mounted onto the door body;
the at least one short-range item-identifying sensor being oriented away from the collapsible tube; and
the at least one short-range item-identifying sensor being electronically connected to the controller.

3. The delivery-receiving door as claimed in claim 2, wherein the at least one short-range item-identifying sensor is selected from a group consisting of: a radio-frequency identification (RFID) sensor, a quick response (QR) code scanner, a personal-area networking transceiver, and combinations thereof.

4. The delivery-receiving door as claimed in claim 1 comprises:
at least one short-range user-identifying sensor;
the at least one short-range user-identifying sensor being mounted onto the door body;
the at least one short-range user-identifying sensor being oriented away from the collapsible tube; and
the at least one short-range user-identifying sensor being electronically connected to the controller.

5. The delivery-receiving door as claimed in claim 4, wherein the at least one short-range user-identifying sensor is selected from a group consisting of: a radio-frequency identification (RFID) sensor, an optical scanner, a personal-area networking transceiver, a biometric scanner, and combinations thereof.

6. The delivery-receiving door as claimed in claim 1 comprises:
a camera;
the camera being pivotably mounted onto the door body;
the camera being oriented away from the collapsible tube; and
the camera being electronically connected to the controller.

7. The delivery-receiving door as claimed in claim 1 comprises:
a user interface;
the user interface being mounted onto the door body;
the user interface being oriented away from the collapsible tube; and
the user interface being electronically connected to the controller.

8. The delivery-receiving door as claimed in claim 1 comprises:
a speaker;
the speaker being mounted onto the door body;
the speaker being oriented towards the collapsible tube; and
the speaker being electronically connected to the controller.

9. The delivery-receiving door as claimed in claim 1 comprises:
a wireless transceiver; and
the wireless transceiver being electronically connected to the controller.

10. The delivery-receiving door as claimed in claim 1 comprises:
the first access mechanism comprises a first thermally-insulated door and a security gate;
the security gate being operatively coupled to the first open end, wherein the security gate is used to provide selective access to the collapsible tube;
the first thermally-insulated door being operatively coupled to the first open end, wherein the first thermally-insulated door is used to thermally regulate the collapsible tube; and
the security gate being positioned in between the first thermally-insulated door and the first open end.

11. The delivery-receiving door as claimed in claim 1 comprises:
the second access mechanism being a second thermally-insulated door; and
the second thermally-insulated door being operatively coupled to the second open end, wherein the second thermally-insulated door is used to thermally regulate the collapsible tube.

12. The delivery-receiving door as claimed in claim 1 comprises:
a plurality of collapsible dividers;
the plurality of collapsible dividers being mounted within the collapsible tube; and
a plurality of compartments of the collapsible tube being delineated by the plurality of collapsible dividers.

13. The delivery-receiving door as claimed in claim 12 comprises:
a refrigeration system; and
the refrigeration system being in thermal communication with at least one compartment from the plurality of compartments.

14. A delivery-receiving door comprises:
an exterior door;
a collapsible tube;
a controller;
a first access mechanism;
a second access mechanism;
at least one short-range item-identifying sensor;
at least one short-range user-identifying sensor;
the exterior door comprises a door body, a window, and a locking mechanism;
the collapsible tube comprises a first open end and a second open end;
the window traversing normal through the door body;
the first open end being perimetrically connected to the window;
the second open end being positioned offset from the door body;
the first access mechanism being operatively integrated into the first open end, wherein the first access mechanism is used to selectively allow access to the collapsible tube;
the second access mechanism being operatively integrated into the second open end, wherein the second access mechanism is used to selectively allow access to the collapsible tube;
the controller being electronically connected to the locking mechanism and the first access mechanism;
the at least one short-range item-identifying sensor being mounted onto the door body;
the at least one short-range item-identifying sensor being oriented away from the collapsible tube;
the at least one short-range item-identifying sensor being electronically connected to the controller;
the at least one short-range user-identifying sensor being mounted onto the door body;
the at least one short-range user-identifying sensor being oriented away from the collapsible tube; and
the at least one short-range user-identifying sensor being electronically connected to the controller.

15. The delivery-receiving door as claimed in claim 14, wherein the at least one short-range item-identifying sensor is selected from a group consisting of: a radio-frequency identification (RFID) sensor, a quick response (QR) code scanner, a personal-area networking transceiver, and combinations thereof.

16. The delivery-receiving door as claimed in claim 14, wherein the at least one short-range user-identifying sensor is selected from a group consisting of: a radio-frequency identification (RFID) sensor, an optical scanner, a personal-area networking transceiver, a biometric scanner, and combinations thereof.

17. The delivery-receiving door as claimed in claim 14 comprises:
a camera;
a user interface;
a speaker;
a wireless transceiver;
the camera being pivotably mounted onto the door body;
the user interface and the speaker being mounted onto the door body;
the camera, user interface, and speaker being oriented away from the collapsible tube; and
the camera, user interface, speaker, and wireless transceiver being electronically connected to the controller.

18. The delivery-receiving door as claimed in claim 14 comprises:
the first access mechanism comprises a first thermally-insulated door and a security gate;
the security gate being operatively coupled to the first open end, wherein the security gate is used to provide selective access to the collapsible tube;
the first thermally-insulated door being operatively coupled to the first open end, wherein the first thermally-insulated door is used to thermally regulate the collapsible tube; and
the security gate being positioned in between the first thermally-insulated door and the first open end.

19. The delivery-receiving door as claimed in claim 14 comprises:
the second access mechanism being a second thermally-insulated door; and
the second thermally-insulated door being operatively coupled to the second open end, wherein the second thermally-insulated door is used to thermally regulate the collapsible tube.

20. The delivery-receiving door as claimed in claim 14 comprises:
a plurality of collapsible dividers;
a refrigeration system;
the plurality of collapsible dividers being mounted within the collapsible tube;
a plurality of compartments of the collapsible tube being delineated by the plurality of collapsible dividers; and
the refrigeration system being in thermal communication with at least one compartment from the plurality of compartments.
